(19) United States
(12) Patent Application Publication
(10) Pub. No.: US 2026/0212011 A1
(43) Pub. Date: Jul. 23, 2026

(54) System, Method, and Computer Program Product for Real-Time Change Detection

(71) Applicant: Visa International Service Association, San Francisco, CA (US)

(72) Inventors: Linyun He, Cedar Park, TX (US); Shubham Agrawal, Round Rock, TX (US); Chiranjeet Chetia, Round Rock, TX (US); Harishkumar Sundarji Majithiya, Austin, TX (US); Mayrose Pacis Kragas, Foster City, CA (US); Jason Keith Kauspedas, Monument, CO (US); Shizhe Ma, Bellevue, WA (US)

(21) Appl. No.: 19/141,542

(22) PCT Filed: Dec. 21, 2023
(86) PCT No.: PCT/US2023/085446

§ 371 Date: Jun. 20, 2025

Related U.S. Application Data
(60) Provisional application No. 63/434,962, filed on Dec. 23, 2022.

(51) Int. Cl. G06F 21/55

(52) U.S. Cl. CPC G06F 21/554; G06F 2221/034

(57) ABSTRACT

Described are a system, method, and computer program product for real-time change detection. The system includes at least one processor configured to receive transaction data associated with a transaction associated with an entity, and determine an aggregate value based on a portion of the transaction data for the transaction. The at least one processor is also configured to generate a predicted aggregate value for the entity by inputting historic transaction data associated with a plurality of historic transactions associated with the entity to a machine learning model. The at least one processor is further configured to determine a deviation of the aggregate value from the predicted aggregate value, and compare the deviation to a dynamic threshold associated with the entity. The at least one processor is further configured to, in response to determining that the deviation satisfies the dynamic threshold, trigger a risk mitigation process associated with the entity.

### CROSS-REFERENCE TO RELATED APPLICATIONS

This application is the United States national phase of International Application No. PCT/US23/85446, filed Dec. 21, 2023, and claims priority to U.S. Provisional Patent Application No. 63/434,962, filed Dec. 23, 2022, the disclosures of which are incorporated by reference herein in their entireties.

### BACKGROUND

### 1. Technical Field

This disclosure relates generally to change detection in networked systems, and, in some non-limiting embodiments or aspects, to systems, methods, and computer program products for real-time change detection in network activity based on entity-level historic behavior.

### 2. Technical Considerations

Systems that detect changes (e.g., deviations, outliers, etc.) in entity activity may suffer from increased occurrences of false positives due to individual entities exhibiting behavior (e.g., a pattern of activity) in a network that is normal (e.g., typical) for the individual entity, but which is generally abnormal (e.g., atypical) for entities that share one or more features with the individual entity. Such systems, therefore, may erroneously identify the normal behavior of the individual entity as being abnormal. Similarly, such systems may also suffer from increased occurrences of false negatives due to individual entities exhibiting behavior in the network that is abnormal for the individual entity, but which is generally normal for entities that share one or more features with the individual entity. Such systems, therefore, may erroneously identify the abnormal behavior of the individual entity as being normal.

Moreover, what is normal for an entity may change over time. For example, network behavior that is normal for an individual entity in one time period may not necessarily be representative of normal behavior for the same entity in a later time period. Therefore, false positives and false negatives that are created by individualistic behavior are further exacerbated by changes in the individualistic behavior over time. Additionally, existing solutions may not timely adapt to changes in entity activity.

There is a need in the art for a technical solution to more accurately identify changes in entity-level activity, including on a real-time basis, and dynamically adjusts thresholds over time for detecting changes in activity.

### SUMMARY

Accordingly, provided are improved systems, methods, and computer program products for real-time change detection.

According to some non-limiting embodiments or aspects, provided is a system for real-time change detection. The system includes at least one processor configured to receive transaction data associated with at least one transaction associated with an entity. The at least one processor is also configured to determine at least one aggregate value based on at least a portion of the transaction data for the at least one transaction. The at least one processor is further configured to generate at least one predicted aggregate value for the entity by inputting historic transaction data associated with a plurality of historic transactions associated with the entity to a machine learning model. The at least one processor is further configured to determine a deviation of the at least one aggregate value from the at least one predicted aggregate value. The at least one processor is further configured to compare the deviation to a dynamic threshold associated with the entity. The at least one processor is further configured to, in response to determining that the deviation satisfies the dynamic threshold, trigger at least one risk mitigation process associated with the entity.

In some non-limiting embodiments or aspects, when receiving the transaction data associated with the at least one transaction, the at least one processor may be configured to receive the transaction data associated with the at least one transaction in a first time period. The at least one processor may be further configured to receive the historic transaction data associated with the plurality of historic transactions in a training time period preceding the first time period. The at least one processor may be further configured to determine at least one historic aggregate value based on at least a portion of the historic transaction data for the plurality of historic transactions, based on a type of entity associated with the plurality of historic transactions. The at least one processor may be further configured to train the machine learning model with the at least one historic aggregate value, wherein the machine learning model is configured to predict at least one future value of transaction data for future transactions.

In some non-limiting embodiments or aspects, a type of the entity may include at least one of: transaction account, merchant, acquirer, issuer, or any combination thereof. The at least one risk mitigation process may include at least one of: temporarily declining future transactions associated with the entity, transmitting an alert to the entity, temporarily disabling system access for the entity, or any combination thereof.

In some non-limiting embodiments or aspects, the at least one processor may be further configured to automatically and periodically update the dynamic threshold based on ongoing transactions associated with the entity. The deviation may be based at least partly on a moving standard deviation. When updating the dynamic threshold based on the ongoing transactions associated with the entity, the at least one processor may be configured to: determine the deviation of the at least one aggregate value from the at least one predicted aggregate value for each subperiod of a time period in which the ongoing transactions are completed, to produce a plurality of deviations; and update the dynamic threshold after each subperiod of the time period based at least partly on a maximum value of the plurality of deviations.

In some non-limiting embodiments or aspects, the at least one processor may be further configured to retrain the machine learning model based on the ongoing transactions to produce an updated machine learning model. When determining the deviation of the at least one aggregate value from the at least one predicted aggregate value for each subperiod of the time period, the at least one processor may be configured to regenerate the at least one predicted aggregate value for the entity based on the updated machine learning model.

According to some non-limiting embodiments or aspects, provided is a method for real-time change detection. The method includes receiving, with at least one processor, transaction data associated with at least one transaction associated with an entity. The method also includes determining, with at least one processor, at least one aggregate value based on at least a portion of the transaction data for the at least one transaction. The method further includes generating, with at least one processor, at least one predicted aggregate value for the entity by inputting historic transaction data associated with a plurality of historic transactions associated with the entity to a machine learning model. The method further includes determining, with at least one processor, a deviation of the at least one aggregate value from the at least one predicted aggregate value. The method further includes comparing, with at least one processor, the deviation to a dynamic threshold associated with the entity. The method further includes, in response to determining that the deviation satisfies the dynamic threshold, triggering, with at least one processor, at least one risk mitigation process associated with the entity.

In some non-limiting embodiments or aspects, receiving the transaction data associated with the at least one transaction may include receiving the transaction data associated with the at least one transaction in a first time period. The method may further include receiving, with at least one processor, the historic transaction data associated with the plurality of historic transactions in a training time period preceding the first time period. The method may further include determining, with at least one processor, at least one historic aggregate value based on at least a portion of the historic transaction data for the plurality of historic transactions, based on a type of entity associated with the plurality of historic transactions. The method may further include training, with at least one processor, the machine learning model with the at least one historic aggregate value, wherein the machine learning model is configured to predict at least one future value of transaction data for future transactions.

In some non-limiting embodiments or aspects, a type of the entity may include at least one of: transaction account, merchant, acquirer, issuer, or any combination thereof. The at least one risk mitigation process may include at least one of: temporarily declining future transactions associated with the entity, transmitting an alert to the entity, temporarily disabling system access for the entity, or any combination thereof.

In some non-limiting embodiments or aspects, the method may further include automatically and periodically updating, with at least one processor, the dynamic threshold based on ongoing transactions associated with the entity. The deviation may be based at least partly on a moving standard deviation, and updating the dynamic threshold based on the ongoing transactions associated with the entity may include: determining the deviation of the at least one aggregate value from the at least one predicted aggregate value for each subperiod of a time period in which the ongoing transactions are completed to produce a plurality of deviations; and updating the dynamic threshold after each subperiod of the time period based at least partly on a maximum value of the plurality of deviations.

In some non-limiting embodiments or aspects, the method may further include retraining, with at least one processor, the machine learning model based on the ongoing transactions to produce an updated machine learning model. Determining the deviation of the at least one aggregate value from the at least one predicted aggregate value for each subperiod of the time period further may include regenerating, during the time period, the at least one predicted aggregate value for the entity based on the updated machine learning model.

In some non-limiting embodiments or aspects, the machine learning model may include a long short-term memory (LSTM) model.

According to some non-limiting embodiments or aspects, provided is a computer program product for real-time change detection. The computer program product may include at least one non-transitory computer-readable medium including program instructions that, when executed by at least one processor, cause the at least one processor to receive transaction data associated with at least one transaction associated with an entity. The program instructions also cause the at least one processor to determine at least one aggregate value based on at least a portion of the transaction data for the at least one transaction. The program instructions also cause the at least one processor to generate at least one predicted aggregate value for the entity by inputting historic transaction data associated with a plurality of historic transactions associated with the entity to a machine learning model. The program instructions also cause the at least one processor to determine a deviation of the at least one aggregate value from the at least one predicted aggregate value. The program instructions also cause the at least one processor to compare the deviation to a dynamic threshold associated with the entity. The program instructions also cause the at least one processor to, in response to determining that the deviation satisfies the dynamic threshold, trigger at least one risk mitigation process associated with the entity.

In some non-limiting embodiments or aspects, the program instructions that cause the at least one processor to receive the transaction data associated with the at least one transaction, may cause the at least one processor to receive the transaction data associated with the at least one transaction in a first time period. The program instructions may further cause the at least one processor to receive the historic transaction data associated with the plurality of historic transactions in a training time period preceding the first time period. The program instructions may further cause the at least one processor to determine at least one historic aggregate value based on at least a portion of the historic transaction data for the plurality of historic transactions, based on a type of entity associated with the plurality of historic transactions. The program instructions may further cause the at least one processor to train the machine learning model with the at least one historic aggregate value, wherein the machine learning model is configured to predict at least one future value of transaction data for future transactions.

In some non-limiting embodiments or aspects, a type of the entity may include at least one of: transaction account, merchant, acquirer, issuer, or any combination thereof. The at least one risk mitigation process may include at least one of: temporarily declining future transactions associated with the entity, transmitting an alert to the entity, temporarily disabling system access for the entity, or any combination thereof.

In some non-limiting embodiments or aspects, the program instructions may further cause the at least one processor to automatically and periodically update the dynamic threshold based on ongoing transactions associated with the entity. The deviation may be based at least partly on a moving standard deviation. The program instructions that cause the at least one processor to update the dynamic threshold based on the ongoing transactions associated with the entity, may cause the at least one processor to: determine the deviation of the at least one aggregate value from the at least one predicted aggregate value for each subperiod of a time period in which the ongoing transactions are completed, to produce a plurality of deviations; and update the dynamic threshold after each subperiod of the time period based at least partly on a maximum value of the plurality of deviations.

In some non-limiting embodiments or aspects, the program instructions may further cause the at least one processor to retrain the machine learning model based on the ongoing transactions to produce an updated machine learning model. The program instructions that cause the at least one processor to determine the deviation of the at least one aggregate value from the at least one predicted aggregate value for each subperiod of the time period, may cause the at least one processor to regenerate the at least one predicted aggregate value for the entity based on the updated machine learning model.

Other non-limiting embodiments or aspects will be set forth in the following numbered clauses:

Clause 1: A system comprising at least one processor configured to: receive transaction data associated with at least one transaction associated with an entity; determine at least one aggregate value based on at least a portion of the transaction data for the at least one transaction; generate at least one predicted aggregate value for the entity by inputting historic transaction data associated with a plurality of historic transactions associated with the entity to a machine learning model; determine a deviation of the at least one aggregate value from the at least one predicted aggregate value; compare the deviation to a dynamic threshold associated with the entity; and in response to determining that the deviation satisfies the dynamic threshold, trigger at least one risk mitigation process associated with the entity.

Clause 2: The system of clause 1, wherein, when receiving the transaction data associated with the at least one transaction, the at least one processor is configured to: receive the transaction data associated with the at least one transaction in a first time period; and wherein the at least one processor is further configured to: receive the historic transaction data associated with the plurality of historic transactions in a training time period preceding the first time period; determine at least one historic aggregate value based on at least a portion of the historic transaction data for the plurality of historic transactions, based on a type of entity associated with the plurality of historic transactions; and train the machine learning model with the at least one historic aggregate value, wherein the machine learning model is configured to predict at least one future value of transaction data for future transactions.

Clause 3: The system of clause 1 or clause 2, wherein a type of the entity comprises at least one of: transaction account, merchant, acquirer, issuer, or any combination thereof; and wherein the at least one risk mitigation process comprises at least one of: temporarily declining future transactions associated with the entity, transmitting an alert to the entity, temporarily disabling system access for the entity, or any combination thereof.

Clause 4: The system of any of clauses 1-3, wherein the at least one processor is further configured to automatically and periodically update the dynamic threshold based on ongoing transactions associated with the entity.

Clause 5: The system of any of clauses 1-4, wherein the deviation is based at least partly on a moving standard deviation, and wherein, when updating the dynamic threshold based on the ongoing transactions associated with the entity, the at least one processor is configured to: determine the deviation of the at least one aggregate value from the at least one predicted aggregate value for each subperiod of a time period in which the ongoing transactions are completed, to produce a plurality of deviations; and update the dynamic threshold after each subperiod of the time period based at least partly on a maximum value of the plurality of deviations.

Clause 6: The system of any of clauses 1-5, wherein the at least one processor is further configured to retrain the machine learning model based on the ongoing transactions to produce an updated machine learning model, and wherein, when determining the deviation of the at least one aggregate value from the at least one predicted aggregate value for each subperiod of the time period, the at least one processor is configured to: regenerate the at least one predicted aggregate value for the entity based on the updated machine learning model.

Clause 7: A computer-implemented method, comprising: receiving, with at least one processor, transaction data associated with at least one transaction associated with an entity; determining, with at least one processor, at least one aggregate value based on at least a portion of the transaction data for the at least one transaction; generating, with at least one processor, at least one predicted aggregate value for the entity by inputting historic transaction data associated with a plurality of historic transactions associated with the entity to a machine learning model; determining, with at least one processor, a deviation of the at least one aggregate value from the at least one predicted aggregate value; comparing, with at least one processor, the deviation to a dynamic threshold associated with the entity; and in response to determining that the deviation satisfies the dynamic threshold, triggering, with at least one processor, at least one risk mitigation process associated with the entity.

Clause 8: The computer-implemented method of clause 7, wherein receiving the transaction data associated with the at least one transaction comprises: receiving the transaction data associated with the at least one transaction in a first time period; the method further comprising: receiving, with at least one processor, the historic transaction data associated with the plurality of historic transactions in a training time period preceding the first time period; determining, with at least one processor, at least one historic aggregate value based on at least a portion of the historic transaction data for the plurality of historic transactions, based on a type of entity associated with the plurality of historic transactions; and training, with at least one processor, the machine learning model with the at least one historic aggregate value, wherein the machine learning model is configured to predict at least one future value of transaction data for future transactions.

Clause 9: The computer-implemented method of clause 7 or clause 8, wherein a type of the entity comprises at least one of: transaction account, merchant, acquirer, issuer, or any combination thereof.

Clause 10: The computer-implemented method of any of clauses 7-9, wherein the at least one risk mitigation process comprises at least one of: temporarily declining future transactions associated with the entity, transmitting an alert to the entity, temporarily disabling system access for the entity, or any combination thereof.

Clause 11: The computer-implemented method of any of clauses 7-10, further comprising automatically and periodically updating, with at least one processor, the dynamic threshold based on ongoing transactions associated with the entity.

Clause 12: The computer-implemented method of any of clauses 7-11, wherein the deviation is based at least partly on a moving standard deviation, and wherein updating the dynamic threshold based on the ongoing transactions associated with the entity comprises: determining the deviation of the at least one aggregate value from the at least one predicted aggregate value for each subperiod of a time period in which the ongoing transactions are completed, to produce a plurality of deviations; and updating the dynamic threshold after each subperiod of the time period based at least partly on a maximum value of the plurality of deviations.

Clause 13: The computer-implemented method of any of clauses 7-12, further comprising retraining, with at least one processor, the machine learning model based on the ongoing transactions to produce an updated machine learning model, wherein determining the deviation of the at least one aggregate value from the at least one predicted aggregate value for each subperiod of the time period further comprises: regenerating, during the time period, the at least one predicted aggregate value for the entity based on the updated machine learning model.

Clause 14: The computer-implemented method of any of clauses 7-13, wherein the machine learning model is a LSTM model.

Clause 15: A computer program product comprising at least one non-transitory computer-readable medium comprising program instructions that, when executed by at least one processor, cause the at least one processor to: receive transaction data associated with at least one transaction associated with an entity; determine at least one aggregate value based on at least a portion of the transaction data for the at least one transaction; generate at least one predicted aggregate value for the entity by inputting historic transaction data associated with a plurality of historic transactions associated with the entity to a machine learning model; determine a deviation of the at least one aggregate value from the at least one predicted aggregate value; compare the deviation to a dynamic threshold associated with the entity; and in response to determining that the deviation satisfies the dynamic threshold, trigger at least one risk mitigation process associated with the entity.

Clause 16: The computer program product of clause 15, wherein the program instructions that cause the at least one processor to receive the transaction data associated with the at least one transaction, cause the at least one processor to: receive the transaction data associated with the at least one transaction in a first time period; and wherein the program instructions further cause the at least one processor to: receive the historic transaction data associated with the plurality of historic transactions in a training time period preceding the first time period; determine at least one historic aggregate value based on at least a portion of the historic transaction data for the plurality of historic transactions, based on a type of entity associated with the plurality of historic transactions; and train the machine learning model with the at least one historic aggregate value, wherein the machine learning model is configured to predict at least one future value of transaction data for future transactions.

Clause 17: The computer program product of clause 15 or clause 16, wherein a type of the entity comprises at least one of: transaction account, merchant, acquirer, issuer, or any combination thereof; and wherein the at least one risk mitigation process comprises at least one of: temporarily declining future transactions associated with the entity, transmitting an alert to the entity, temporarily disabling system access for the entity, or any combination thereof.

Clause 18: The computer program product of any of clauses 15-17, wherein the program instructions further cause the at least one processor to automatically and periodically update the dynamic threshold based on ongoing transactions associated with the entity.

Clause 19: The computer program product of any of clauses 15-18, wherein the deviation is based at least partly on a moving standard deviation, and wherein the program instructions that cause the at least one processor to update the dynamic threshold based on the ongoing transactions associated with the entity, cause the at least one processor to: determine the deviation of the at least one aggregate value from the at least one predicted aggregate value for each subperiod of a time period in which the ongoing transactions are completed, to produce a plurality of deviations; and update the dynamic threshold after each subperiod of the time period based at least partly on a maximum value of the plurality of deviations.

Clause 20: The computer program product of any of clauses 15-19, wherein the program instructions further cause the at least one processor to retrain the machine learning model based on the ongoing transactions to produce an updated machine learning model, and wherein the program instructions that cause the at least one processor to determine the deviation of the at least one aggregate value from the at least one predicted aggregate value for each subperiod of the time period, cause the at least one processor to: regenerate the at least one predicted aggregate value for the entity based on the updated machine learning model.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the disclosure are explained in greater detail below with reference to the exemplary embodiments or aspects that are illustrated in the accompanying schematic figures, in which:

FIG. 1 is a schematic diagram of a system for real-time change detection, according to some non-limiting embodiments or aspects;

FIG. 2 is a schematic diagram of example components of one or more devices of FIG. 1, according to some non-limiting embodiments or aspects;

FIG. 3 is a flow diagram of a method for real-time change detection, according to some non-limiting embodiments or aspects;

FIG. 4 is a flow diagram of a method for real-time change detection, according to some non-limiting embodiments or aspects;

FIG. 5 is a flow diagram of a method for real-time change detection, according to some non-limiting embodiments or aspects; and

FIG. 6 is a data-flow diagram of a system and method for real-time change detection, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, one or more computing devices used by a payment device provider system, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the present disclosure provide an improved system for real-time (e.g., as data is being communicated/received, as soon as data is practically available after data is communicated/received, during processing and/or communication of messages related to an event such as a transaction, at the time of processing and/or making a decision related to an event, and/or the like) change detection (e.g., detecting changes, such as outlier transaction behavior, based on dynamic thresholds that have been periodically updated and are relevant to the present examined time step). To illustrate, electronic payment processing networks may process millions of transactions a day. Accurately and quickly identifying changes in transaction behavior (e.g., anomalies, fraudulent transactions, new spending patterns, changes in preferences or habits, etc.) is important to the efficient functioning of an electronic payment processing network, particularly for the transaction service provider and associated communications. False negatives in change detection may allow electronic transactions to be continued to be processed, which may require additional computer resources (e.g., memory, bandwidth, number of communications) to rectify. Moreover, changes in activity may be associated with high-volume attacks, leading to wasted computer resources in processing transactions that should have been prevented by early detection. Additionally, the amount of computer resources required to rectify (e.g., engage risk mitigation processes, restore account states, etc.) malicious activity associated with certain types of changes in behavior may increase the longer that the changes go undetected. Therefore, it is important to identify changes in activity as close to the occurrence of the activity as possible.

Furthermore, false positives in change detection may prevent the proper functioning of an electronic payment processing network, wherein functionalities of the network (e.g., transaction processing, sending/receiving communications) to particular entities may be disabled or limited in response to falsely identifying malicious changes in transaction behavior. Likewise, false positives may require additional computer resources to remedy once identified. Therefore, improvements to the accuracy and reaction time of a monitoring system for change detection will result in direct technical improvements to the electronic payment processing network and the allocation of computer resources therein. Described systems and methods improve the accuracy and reaction time of such systems by generating risk assessments based on entity-level aggregated data (e.g., comparing aggregated values of transaction data in one time period as compared to a historic or training time period) and using a machine learning model trained on historic data for an entity. Such processes improve the accuracy and reaction time by dynamically adjusting threshold values for triggering risk mitigating processes, and by tailoring risk values based on aggregated values associated with an evaluated entity. In that manner, if an entity exhibits transaction behavior that is appropriate or in character with its own historic behavior, false positives will be reduced that might otherwise be identified when comparing the entity to other entities. Likewise, if an entity exhibits transaction behavior that is unusual or not in character with its own historic behavior, false negatives will be reduced that might otherwise be identified when comparing the entity to other entities. Additionally, dynamic adjusting thresholds allow for individual entity behavior to change over time when accounting for risk identification, so that change detection may adapt to the entity's most current representative behavior. Further technical improvements are provided by the described learning model being self-supervised, such that data may be detected and labeled without external supervisory input. In this way, computer resources and time are saved in not needing pre-labeled data. Moreover, self-supervised learning provides for automatically improved performance over time, by automatically learning normal behavior to predict future events, and by automatically comparing differences in predicted events and actual events, which saves on computer resources and time as compared to supervised learning models.

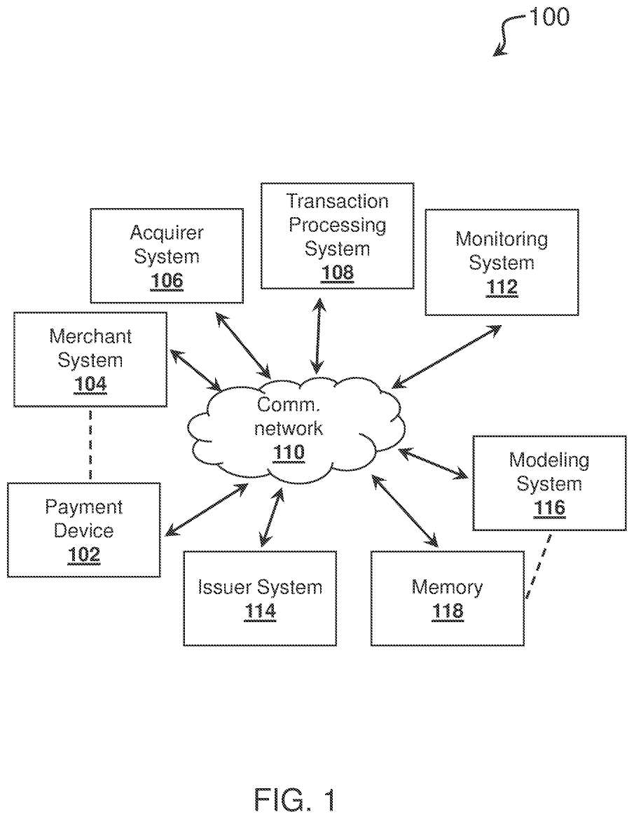

Referring now to FIG. 1, illustrated is a diagram of an example environment 100 in which devices, systems, and/or methods, described herein, may be implemented. As shown in FIG. 1, environment 100 may include payment device 102, merchant system 104, acquirer system 106, transaction processing system 108, monitoring system 112, issuer system 114, modeling system 116, memory 118, and communication network 110. Each of the foregoing devices and/or systems may include one or more computing devices configured to communicate (e.g., directly and/or indirectly via communication network 110) with other devices and/or systems in the environment 100.

Merchant system 104 may include one or more computing devices (e.g., servers, point-of-sale (POS) devices, and/or the like) configured to communicate with payment device 102, acquirer system 106, monitoring system 112, and/or transaction processing system 108 (e.g., via communication network 110). Merchant system 104 may include at least one POS device and may communicate with payment device 102 to initiate a transaction between an account of the merchant (e.g., a financial institution transaction account associated with an acquirer) and an account of a payment device holder (e.g., a financial institution transaction account associated with an issuer). Merchant system 104 may communicate with an acquirer system 106 to generate and communicate one or more transaction authorization requests associated with one or more transactions to transaction processing system 108.

Acquirer system 106 may be an acquirer system, as described herein. Acquirer system 106 may be configured to communicate with monitoring system 112, merchant system 104, and/or transaction processing system 108 (e.g., via communication network 110). Acquirer system 106 may receive (and/or communicate with merchant system 104 to generate) authorization requests, and/or acquirer system 106 may communicate the authorization requests to transaction processing system 108.

Transaction processing system 108 may be a transaction processing system, as described herein. Transaction processing system 108 may be configured to communicate with acquirer system 106, monitoring system 112, issuer system 114, memory 118, and/or modeling system 116 (e.g., via communication network 110). Transaction processing system 108 may receive transaction authorization requests from acquirer system 106 and transmit (and/or communicate with issuer system 114 to generate) transaction authorization responses to acquirer system 106.

Issuer system 114 may be an issuer system, as described herein. Issuer system 114 may be configured to communicate with monitoring system 112 and/or transaction processing system 108 (e.g., via communication network 110). Issuer system 114 may communicate with transaction processing system 108 to generate transaction authorization responses to acquirer system 106.

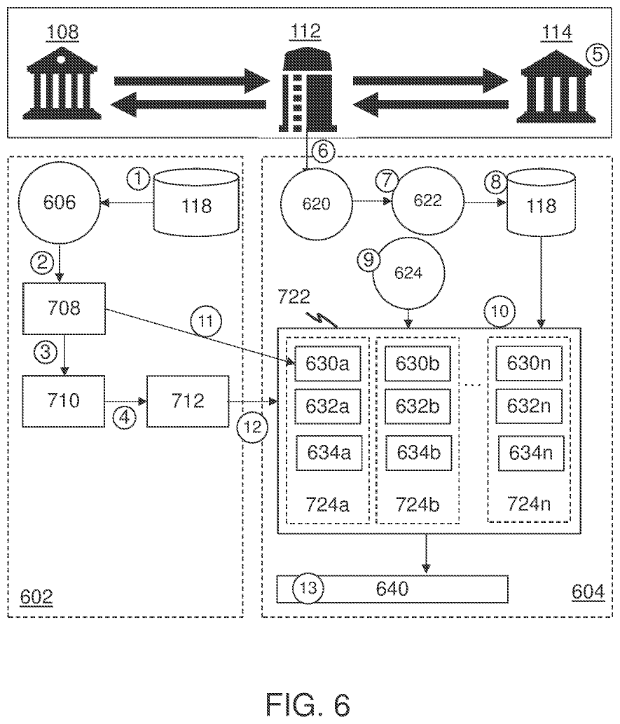

Monitoring system 112 may include one or more computing devices (e.g., servers and/or the like) configured to communicate with payment device 102, merchant system 104, acquirer system 106, a transaction processing system 108, issuer system 114, modeling system 116, and/or memory 118 (e.g., via communication network 110). Monitoring system 112 may be configured to monitor transactions being processed in transaction processing system 108, aggregate one or more values of parameters of transaction data in association with one or more entities, and trigger one or more risk mitigation processes. Transaction data may include one or more values for one or more parameters of one or more transactions, including, but not limited to, transaction amount, transaction time, merchant identifier, payment device identifier, account identifier, merchant category (e.g., gasoline, retail, etc.), transaction type (e.g., online, in-person, etc.), and/or the like. Risk mitigation processes may include, but are not limited to, transmitting alerts to one or more devices shown in FIG. 1, declining incoming transactions (e.g., triggering transaction processing system 108 and/or issuer system 114 to decline incoming transactions) associated with one or more accounts associated with the entity or transactions being processed in association with the entity, disabling (at least partly) system access for the entity (e.g., removing or disabling permissions to engage in certain network activities), and/or the like. Monitoring system 112 may include a cluster of server nodes (e.g., an entity processing cluster), as described herein (e.g., cluster 722 depicted in FIG. 6). A cluster of server nodes may be managed (e.g., resource allocated and controlled) by an entity distribution process on a same or different server. Monitoring system 112 may include a fraud detection and risk mitigation system. Transaction processing system 108 may include monitoring system 112. Monitoring system 112 may include memory 118.

Modeling system 116 may include one or more computing devices (e.g., servers and/or the like) configured to communicate with a transaction processing system 108 to receive at least a portion of transaction data associated with one or more transactions as input to one or more machine learning models. Modeling system 116 may generate, from the one or more machine learning models, output based on the input of at least a portion of transaction data. Modeling system 116 may be further configured to communicate with memory 118 to store and receive stored model states (e.g., hidden states, cell states, etc.) of a machine learning model (e.g., long short-term memory (LSTM) model). Modeling system 116 may include a cluster of server nodes (e.g., an entity processing cluster), as described herein (e.g., cluster 722 depicted in FIG. 6). A cluster of server nodes may be managed (e.g., resource allocated and controlled) by an entity distribution process on a same or different server. Transaction processing system 108 may include modeling system 116 and/or memory 118. Modeling system 116 may include memory 118.

Memory 118 may include one or more computing devices (e.g., servers and/or the like) configured to store aggregated values of transaction data for one or more time periods, machine learning model states (e.g., hidden states, cell states, etc.) of stateful machine learning models, machine learning models for different entities (e.g., including configurations and classifications) and/or the like. Memory 118 may include a cluster of server nodes, as described herein (e.g., cluster 722 depicted in FIG. 6). Each state may be stored in association with an identifier associated with one or more parameters of an input to the stateful machine learning model. For inputs associated with transactions, states may be stored in association with, without limitation, a payment device identifier, an account identifier, a payment device holder identifier, or any combination thereof. In some non-limiting embodiments or aspects, monitoring system 112, modeling system 116, and/or memory 118 may be a same system and/or included in a same system. In some non-limiting embodiments or aspects, one or more of monitoring system 112, modeling system 116, and/or memory 118 may be a same system as transaction processing system 108, and/or included in transaction processing system 108.

Communication network 110 may include one or more wired and/or wireless networks. For example, communication network 110 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, a mesh network, a beacon network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

In some non-limiting embodiments or aspects, transaction processing system 108 may receive (e.g., in a first time period) transaction data associated with at least one transaction (e.g., a credit transaction, a debit transaction, a refund transaction, etc.) associated with an entity (e.g., a transaction account, a payment device holder, a merchant, an acquirer, an issuer, etc.) in a first time period (e.g., a day, a week, a month, etc.). Transaction data may include, but is not limited to, transaction date, transaction time, transaction description, transaction amount, transaction identifier, merchant identifier, payment device identifier, card-present or card-not-present indicator, transaction type (e.g., online, in-person, retail, gasoline, recurring payment, etc.), merchant category, and/or the like.

Transaction processing system 108 and/or modeling system 116 may also determine at least one aggregate value based on at least a portion of the transaction data for the at least one transaction. The at least one aggregate value may be based on at least a portion (e.g., one or more parameters) of the transaction data. In some non-limiting embodiments or aspects, the aggregate value may be associated with, but is not limited to, a count of number of transactions in a time period, a total volume (e.g., summed value amount) of transactions in a time period, a count of number of transactions in a time period for a subset of transactions that meet a predetermined parameter (e.g., count of card-present transactions, count of online transactions, etc.), a total volume of transactions in a time period for a subset of transactions that meet a predetermined parameter, and/or the like.

Transaction processing system 108 and/or modeling system 116 may further generate at least one predicted aggregate value for the entity by inputting historic transaction data associated with a plurality of historic transactions associated with the entity to a machine learning model. Historic transaction data may include transaction data for transactions that occurred in a time period preceding the time period in which the transaction data that is used to determine the at least one aggregate value was received. In some non-limiting embodiments or aspects, the machine learning model may be an LSTM model. The input of the LSTM model may be a three-dimensional array having the dimensions {batch size, time steps, sequence length}, which comprises the historic transaction data (e.g., including the same parameters used to determine the at least one aggregate value). The output of the LSTM model may be a hidden state and a predicted aggregate value at the last time step.

Transaction processing system 108 and/or modeling system 116 may receive historic transaction data associated with a plurality of historic transactions in a training time period (e.g., day, week, month, year, etc.) preceding the first time period in which the transaction data is received and used to determine at least one aggregate value. Transaction processing system 108 and/or modeling system 116 may determine at least one historic aggregate value based on at least a portion of the historic transaction data based on at least a portion of the historic transaction data for the plurality of historic transactions. The at least one historic aggregate value may be based on the type of the entity that is associated with the plurality of historic transactions, and the at least one historic aggregate value may be used to train the machine learning model for use in the first time period. The at least one historic aggregate value may further be specific to transactions associated with the subject entity that is being monitored for changes in transaction behavior. In some non-limiting embodiments or aspects, transaction processing system 108 and/or modeling system 116 may train the machine learning model with the at least one historic aggregate value so as to configure the machine learning model to predict at least one future value of transaction data for future transactions. After the machine learning model is trained as described above, it may be used to generate the at least one predicted aggregate value for the entity.

Transaction processing system 108 and/or modeling system 116 may further determine a deviation of the at least one aggregate value from the at least one predicted aggregate value. The deviation may include a subtractive difference between the at least one aggregate value and the at least one predicted aggregate value. The deviation may further include a standard deviation of a prior time period's (e.g., day, week, month, etc.) aggregate value. In some non-limiting embodiments or aspects, a deviation may be associated with a probability that an outlier in activity has occurred. In some non-limiting embodiments or aspects, the deviation may be determined according to the following formula:

$$s = \frac{1}{( 1 + 4 {e}^{3 - \frac{x - \overline{x}}{σ}} ) ( 1 + {e}^{1000 - x} )} \qquad Formula 1$$

where s is a deviation score, x is the at least one aggregate value for the current time period, x̅ is the at least one predicted aggregate value for the current time period, σ is the standard deviation of a prior time period, and the values 4 and 1000 are predetermined (but modifiable) parameters for generating the deviation score, which were found to have good performance.

Transaction processing system 108, modeling system 116, and/or monitoring system 112 may further compare the deviation to a dynamic threshold associated with the entity. The dynamic threshold may be determined based on the entity's activity, and may be specifically assigned to the entity. Transaction processing system 108 and/or modeling system 116 may determine a dynamic threshold for the entity and for a plurality of other entities, where each dynamic threshold is tailored to an associated entity based on the associated entity's transaction history and/or past determined deviations. The dynamic threshold may include a value such that, if the determined deviation meets and/or exceeds the value of the dynamic threshold, the dynamic threshold may be determined to be satisfied. Transaction processing system 108 and/or modeling system 116 may determine whether the dynamic threshold for the entity is satisfied based on the comparison of the deviation to the dynamic threshold associated with the entity. The dynamic threshold may be automatically and periodically updated by transaction processing system 108 and/or modeling system 116 on a moving time period basis based on ongoing transactions, such that for each increment of time (e.g., day, week, month), the dynamic threshold is updated based the entity's transactions and/or deviations over a given time period (e.g., day, week, month). In some non-limiting embodiments or aspects, the dynamic threshold may be determined according to the following formula:

$$max ( 0.1 , max ( s ) * 1.05 ) , \qquad Formula 2$$

where the dynamic threshold is equal to a value of either 0.1 or five percent more (e.g., multiplying by 1.05) than the maximum value of deviation score s for all s determined in the past time period (e.g., day, week, month), whichever is higher. The above formula may further be based on all s determined in the past time period after deviation scores in the set of s that were determined to be outliers (e.g., satisfied a prior dynamic threshold) are excluded from the set of all s. The values of 0.1 and 1.05 are predetermined (but modifiable) parameters for determining the dynamic threshold, which were found to have good performance.

The standard deviation of the deviation score determination may be a moving standard deviation, such that it is based on a standard deviation for a time period (e.g., a week) preceding the time step for which the deviation score is being calculated. The standard deviation, therefore, may move by virtue of periodically recalculating the deviation score over each subperiod (e.g., a day) of a time period (e.g., a week) in which the ongoing transactions are completed for an entity, to produce a plurality of deviations, each calculated based on a slightly different standard deviation that was determined from a moving time period. Transaction processing system 108 and/or modeling system 116 may automatically and periodically (e.g., every day, week, etc.) update the dynamic threshold based on ongoing transactions associated with the entity, which may include determining the deviation of the at least one aggregate value from the at least one predicted aggregate value for each subperiod of a time period in which the ongoing transactions are completed, to produce a plurality of deviations, and updating the dynamic threshold after each subperiod of the time period based at least partly on a maximum value of the plurality of deviations. Transaction processing system 108 and/or modeling system 116 may further retrain the machine learning model based on the ongoing transaction, such that the ongoing transaction data is used to determine ongoing aggregate values that may be input to the machine learning model for training purposes (e.g., similar to inputting the historic transaction data, but rather on an ongoing, self-improving basis). Using the periodically retrained machine learning model, transaction processing system 108 and/or modeling system 116 may regenerate the at least one predicted aggregate value for the entity for each subperiod of the time period based on the most up-to-date machine learning model. In this manner, not only are the entity-level thresholds configured to be dynamic based on actual historical deviations for entities, but the deviation scores that are used to determine the thresholds may be calculated using the most accurate predicted aggregate values determined from the periodically updated machine learning models.

Transaction processing system 108 and/or modeling system 116 may, in response to determining that the deviation satisfies the dynamic threshold, trigger (e.g., cause an effect immediately after or substantially immediately after the triggering event) at least one risk mitigation process associated with the entity. The at least one risk mitigation process may include, but is not limited to, temporarily declining future transactions associated with the entity (e.g., transactions for payment by a transaction account entity, transactions requested by an acquirer entity, etc.), transmitting an alert to the entity (e.g., to a computing device of a payment device holder entity, to merchant system 104 of a merchant entity, to acquirer system 106 of an acquirer entity, to issuer system 114 of an issuer entity, etc.), temporarily disabling system access for the entity (e.g., removing or disabling permissions to engage in certain network activities, such as requesting payment device information for the entity, modifying preferences or security settings of the entity, etc.).

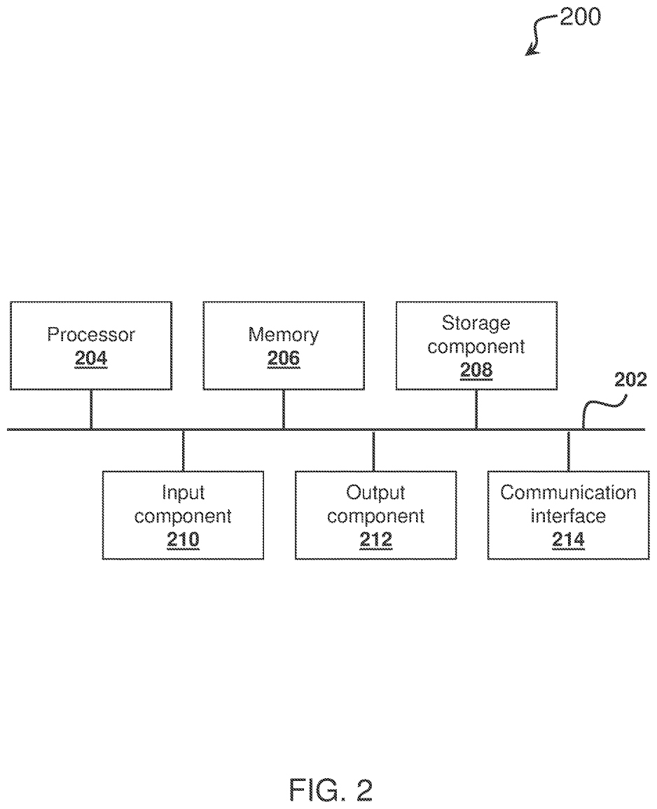

Referring now to FIG. 2, illustrated is a diagram of example components of device 200 according to non-limiting embodiments. Device 200 may correspond to payment device 102, merchant system 104, acquirer system 106, transaction processing system 108, monitoring system 112, modeling system 116, memory 118, issuer system 114, and/or a communication network 110, as an example. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include a bus 202, a processor 204, memory 206, a storage component 208, an input component 210, an output component 212, and a communication interface 214. Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

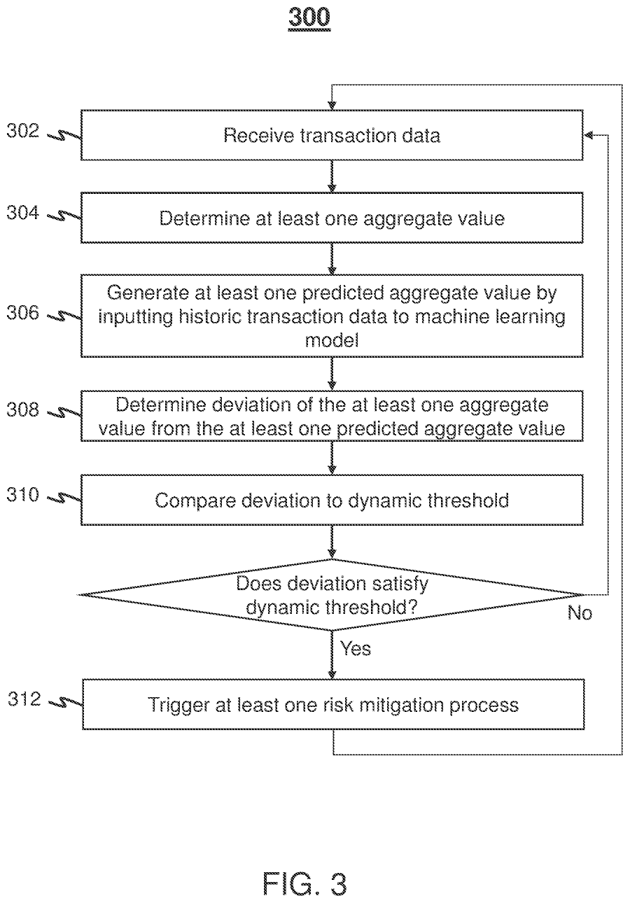

Referring now to FIG. 3, FIG. 3 is a flowchart of a non-limiting embodiment or aspect of a process 300 for real-time change detection, according to some non-limiting embodiments or aspects. The steps shown in FIG. 3 are for example purposes only. It will be appreciated that additional, fewer, different, and/or a different order of steps may be used in non-limiting embodiments or aspects. In some non-limiting embodiments or aspects, one or more of the steps of process 300 may be performed (e.g., completely, partially, and/or the like) by transaction processing system 108, modeling system 116, and/or monitoring system 112. In some non-limiting embodiments or aspects, one or more of the steps of process 300 may be performed (e.g., completely, partially, and/or the like) by another system, another device, another group of systems, or another group of devices, separate from or including transaction processing system 108, modeling system 116, and/or monitoring system 112.

As shown in FIG. 3, at step 302, process 300 may include receiving transaction data. For example, transaction processing system 108 may receive transaction data associated with at least one transaction associated with an entity (e.g., a transaction account, a merchant, an acquirer, an issuer, or any combination thereof). Transaction processing system 108 may store the transaction data in memory 118.

As shown in FIG. 3, at step 304, process 300 may include determining at least one aggregate value. For example, transaction processing system 108 and/or modeling system 116 may determine at least one aggregate value based on at least a portion of the transaction data for the at least one transaction. The aggregate value may be based on transactions associated with the type of the entity, or may be specific to transactions of the entity itself. In some non-limiting embodiments or aspects, transaction processing system 108 and/or modeling system 116 may determine an aggregate value of the total value for transactions of the entity in a first time period.

As shown in FIG. 3, at step 306, process 300 may include generating at least one predicted aggregate value by inputting historic transaction data to a machine learning model. For example, transaction processing system 108 and/or modeling system 116 may generate at least one predicted aggregate value for the entity by inputting historic transaction data associated with a plurality of historic transactions associated with the entity to a machine learning model (e.g., an LSTM model).

As shown in FIG. 3, at step 308, process 300 may include determining a deviation of the at least one aggregate value from the at least one predicted aggregate value. For example, transaction processing system 108, modeling system 116, and/or monitoring system 112 may determine a deviation of the at least one aggregate value from the at least one predicted aggregate value. The deviation may be based at least partly on a moving standard deviation. The deviation may be a score computed based on the moving standard deviation and at least an arithmetic difference between the at least one aggregate value and the at least one predicted value.

As shown in FIG. 3, at step 310, process 300 may include comparing the deviation to a dynamic threshold associated with the entity. For example, transaction processing system 108, modeling system 116, and/or monitoring system 112 may compare the deviation determined in step 308 to a dynamic threshold associated with the entity (e.g., determined specifically based on the entity's transaction history). If the deviation does not satisfy the dynamic threshold, process 300 may continue to monitor for changes by looping back to step 302. If the deviation does satisfy the dynamic threshold, process 300 may continue to step 312 to perform further steps first.

As shown in FIG. 3, at step 312, process 300 may include triggering at least one risk mitigation process. For example, transaction processing system 108, modeling system 116, and/or monitoring system 112 may, in response to determining that the deviation satisfies the dynamic threshold (in step 310), trigger at least one risk mitigation process associated with the entity. The at least one risk mitigation process may include, but is not limited to, temporarily declining future transactions associated with the entity, transmitting an alert to the entity, temporarily disabling system access for the entity, or any combination thereof.

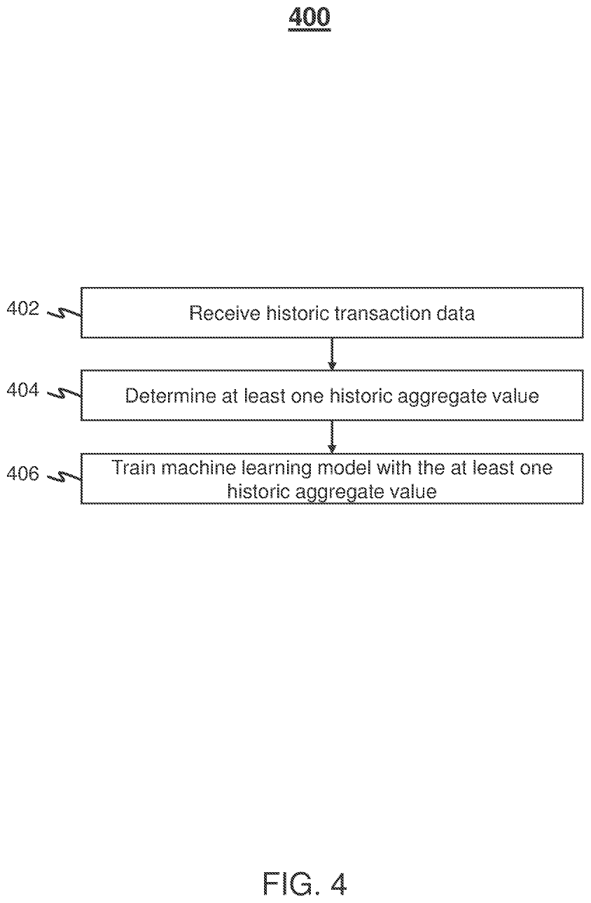

Referring now to FIG. 4, FIG. 4 is a flowchart of a non-limiting embodiment or aspect of a process 400 for real-time change detection, according to some non-limiting embodiments or aspects. The steps shown in FIG. 4 are for example purposes only. It will be appreciated that additional, fewer, different, and/or a different order of steps may be used in non-limiting embodiments or aspects. In some non-limiting embodiments or aspects, one or more of the steps of process 400 may be performed (e.g., completely, partially, and/or the like) by transaction processing system 108, modeling system 116, and/or monitoring system 112. In some non-limiting embodiments or aspects, one or more of the steps of process 400 may be performed (e.g., completely, partially, and/or the like) by another system, another device, another group of systems, or another group of devices, separate from or including transaction processing system 108, modeling system 116, and/or monitoring system 112.

As shown in FIG. 4, at step 402, process 400 may include receiving historic transaction data. For example, transaction processing system 108 and/or modeling system 116 may receive the historic transaction data (of step 306 in process 300, shown in FIG. 3) associated with the plurality of historic transactions in a training time period preceding the first time period (e.g., preceding entirely such that the time periods are non-overlapping, or preceding in part, such that at least part of the training time period precedes the start of the first time period).

As shown in FIG. 4, at step 404, process 400 may include determining at least one historic aggregate value. For example, transaction processing system 108 and/or modeling system 116 may determine at least one historic aggregate value based on at least a portion of the historic transaction data for the plurality of historic transactions, based on a type of entity associated with the plurality of historic transactions. In some non-limiting embodiments or aspects, the portion of the historic transaction data used may be based on the type of entity, such that transaction data for entities as the same type of the evaluated entity are used in the training process for the machine learning model.

As shown in FIG. 4, at step 406, process 400 may include training the machine learning model with the at least one historic aggregate value. For example, transaction processing system 108 and/or modeling system 116 may train the machine learning model with the at least one historic aggregate value (e.g., as training input), such that the machine learning model is configured to predict at least one future value of transaction data for future transactions. In some non-limiting embodiments or aspects, when the at least one historic aggregate value is a total value of transactions for an entity, the future value may be a predicted total value of transactions at a future time step. In some non-limiting embodiments or aspects, when the at least one historic aggregate value is a total count of transactions for an entity, the future value may be a predicted transaction count of transactions at a future time step.

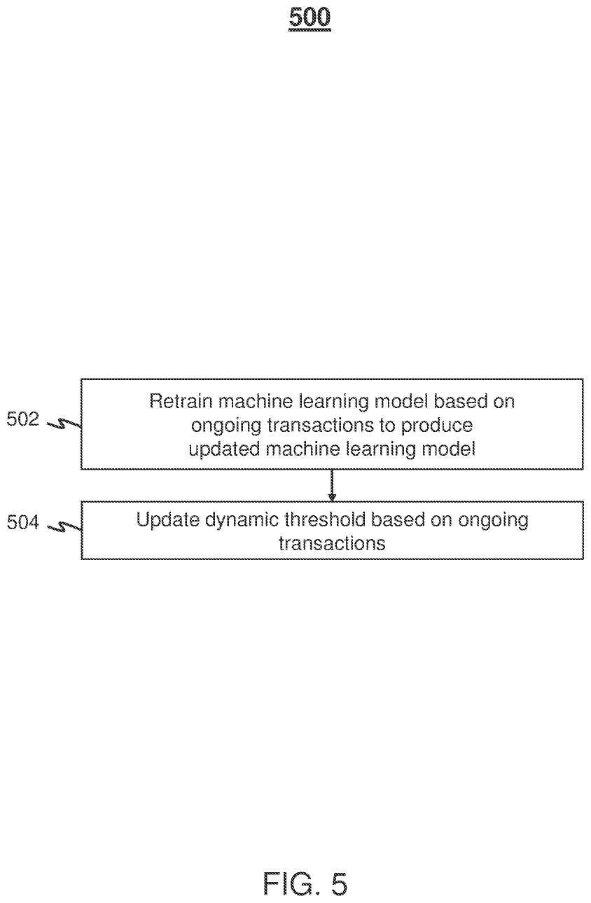

Referring now to FIG. 5, FIG. 5 is a flowchart of a non-limiting embodiment or aspect of a process 500 for real-time change detection, according to some non-limiting embodiments or aspects. The steps shown in FIG. 5 are for example purposes only. It will be appreciated that additional, fewer, different, and/or a different order of steps may be used in non-limiting embodiments or aspects. In some non-limiting embodiments or aspects, one or more of the steps of process 500 may be performed (e.g., completely, partially, and/or the like) by transaction processing system 108, modeling system 116, and/or monitoring system 112. In some non-limiting embodiments or aspects, one or more of the steps of process 500 may be performed (e.g., completely, partially, and/or the like) by another system, another device, another group of systems, or another group of devices, separate from or including transaction processing system 108, modeling system 116, and/or monitoring system 112.

As shown in FIG. 5, at step 502, process 500 may include retraining the machine learning model based on ongoing transactions associated with an entity to produce an updated machine learning model. For example, transaction processing system 108 and/or modeling system 116 may retrain the machine learning model based on the ongoing transactions to produce an updated machine learning model. The ongoing transactions may be used to calculate ongoing aggregate values that may be fed as new training input to the machine learning model, to periodically update the machine learning model for future predictions.

As shown in FIG. 5, at step 504, process 500 may include updating the dynamic threshold based on the ongoing transactions associated with the entity. For example, transaction processing system 108 and/or modeling system 116 may automatically and periodically update the dynamic threshold based on ongoing transactions associated with the entity. In some non-limiting embodiments or aspects, with each new time step (e.g., day) in a time period (e.g., week), the dynamic threshold may be updated based at least on a maximum value of deviation scores for the entity occurring with the incremented time period. By way of further example, transaction processing system 108 and/or modeling system 116, when updating the dynamic threshold based on the ongoing transactions, may determine the deviation of the at least one aggregate value from the at least one predicted aggregate value for each subperiod (e.g., time step) of a time period in which the ongoing transactions are completed to produce a plurality of deviations. Transaction processing system 108 and/or modeling system 116, when updating the dynamic threshold based on the ongoing transactions, may further update the dynamic threshold after each subperiod of the time period based at least partly on a maximum value of the plurality of deviations.

Referring now to FIG. 6, depicted is a data-flow diagram of communications in a system and method for real-time change detection, according to non-limiting embodiments or aspects. The depicted data-flow diagram may be executed, at least partly, in environment 100 of FIG. 1. The data flow diagram includes first process flow 602, which may include processes for training and using the machine learning model and periodically updating the dynamic thresholds for entities. First process flow 602 may occur in parallel with second process flow 604, which may include processes for monitoring and acting on the real-time flow of transactions that are being processed by transaction processing system 108 (e.g., as data is being communicated/received, as soon as data is practically available after data is communicated/received, during processing and/or communication of messages related to an event such as a transaction, at the time of processing and/or making a decision related to an event, and/or the like).

As shown in FIG. 6, at step 1, first process flow 602 may include storing transaction data for each entity of a plurality of entities in memory 118 (e.g., a data lake) that may be used to create entity-level aggregates. First process flow 602 may include subprocess 606, in which transaction processing system 108 and/or modeling system 116 may generate entity-level aggregates for each entity of the plurality of entities. The generated entity-level aggregates may be stored in memory 118.

As shown in FIG. 6, at step 2, first process flow 602 may include training a machine learning model 708 (e.g., an LSTM model) based on the entity-level aggregates to learn normal entity behavior, which is used to predict future entity behavior.

As shown in FIG. 6, at step 3, first process flow 602 may include evaluating deviations of observed entity behavior in comparison to predicted entity behavior with outlier probability calculator 710 (e.g., executed by transaction processing system 108 and/or modeling system 116).

As shown in FIG. 6, at step 4, first process flow 602 may include generating and/or adjusting entity-level dynamic thresholds 712 to trigger risk mitigation actions (e.g., transmission of alerts) when observed entity behavior is sufficiently different from expected (e.g., the deviation satisfies the dynamic thresholds 712). Dynamic thresholds 712 may be configured to self-adjust (e.g., through automatic and periodic updates by transaction processing system 108 and/or modeling system 116) to account for changing entity behavior and to use the latest data to keep false positive rates (e.g., caused by acceptable changes in behavior) lower.

As shown in FIG. 6, at step 5, acquirer system 106 and issuer system 114 may communicate authorization requests and/or authorization responses via transaction processing system 108 to complete transactions for a plurality of entities. For example, the transactions for all entities may be monitored (e.g., by transaction processing system 108 and/or monitoring system 112) for changes in entity-level behavior.

As shown in FIG. 6, at step 6, second process flow 604 may include subprocess 620, which may include streaming transaction data from the ongoing pipeline of processed transactions for all entities. For example, transaction processing system 108 and/or modeling system 116 may identify entities that are being monitored for changes in behavior and may direct transaction data for transactions associated with those entities for further action in second process flow 604, in real-time with processing the transactions (e.g., during processing and/or communication of messages related to each transaction, at the time of processing and/or making a decision related to each transaction, as data is being communicated/received, as soon as data is practically available after data is communicated/received, and/or the like). In this manner, transaction data for entities that are being monitored may be filtered from the pipeline for further aggregation and evaluation for changes in entity-level behavior.

As shown in FIG. 6, at step 7, second process flow 604 may include subprocess 622, which may include generating aggregate values for each entity of the monitored entities, in real-time (e.g., as data is being communicated/received, as soon as data is practically available after data is communicated/received, during processing and/or communication of messages related to a transaction, at the time of processing and/or making a decision related to a transaction, and/or the like). For example, transaction processing system 108, monitoring system 112, and/or modeling system 116 may generate at least one aggregate value from the transaction data for each entity of the plurality of monitored entities. In some non-limiting embodiments or aspects, the entities may be transaction accounts, and the aggregates may be total values (e.g., volume) of transaction for the entities in an evaluated time period. As additional transactions for an entity are processed in an evaluated time period, an aggregate value for the entity may continue to change (e.g., increase) with each processed transaction.

As shown in FIG. 6, at step 8, second process flow 604 may include storing the least one aggregate value of each monitored entity in memory 118 (e.g., which may be a same data store or different data store as used in step 1 in first process flow 602). For example, transaction processing system 108, monitoring system 112, and/or modeling system 116 may store the at least one aggregate value of each entity in memory 118 as they are generated or updated in real-time.

As shown in FIG. 6, at step 9, second process flow 604 may include subprocess 624, which may include distributing aggregated values of monitored entities to different nodes 724a, 724b, 724n of a server cluster 722 for parallel processing. For example, monitoring system 112 may distribute one or more aggregate values for a subset of one or more entities to each node 724a, 724b, 724n of a server cluster 722. In some non-limiting embodiments or aspects, monitoring system 112 may include server cluster 722. The distribution of subprocess 624 may be enhanced to assure that each node 724a, 724b, 724n of server cluster 722 has a sufficient (e.g., reasonable) workload (e.g., not too much or too little volume of entity transactions). As such, and in non-limiting embodiments or aspects, subprocess 624 may include a volume monitoring process, which monitors real-time transaction volume for different entities as data is being sent to each node 724a, 724b, 724n (e.g., as data is being communicated/received, as soon as data is practically available after data is communicated/received, during processing and/or communication of messages related to a transaction, at the time of processing and/or making a decision related to a transaction, and/or the like). Subprocess 624 may further include a shuffle process, which may shuffle the workload of the cluster 722 to redistribute the workload of each node 724a, 724b, 724n should the workload become imbalanced.

In some non-limiting embodiments or aspects, subprocess 624 may further include a resource-based adaptive algorithm, which may be a load-balancing algorithm that uses an agent installed on each node 724a, 724b, 724n of the server cluster 722 that reports on its current load to the load balancer. The installed agent monitors the availability status and resources of the node 724a, 724b, 724n, and the load balancer queries the output from the agent to assist in making load balancing decisions. Subprocess 624 may further include an agent listener that listens to the monitoring agent installed on each node 724a, 724b, 724n of the server cluster.

As shown in FIG. 6, at step 10, second process flow 604 may include prediction subprocess 630a, 630b, 630n and monitoring subprocess 632a, 632b, 632n for each node 724a, 724b, 724n of server cluster 722. In the server cluster 722, for each entity, prediction subprocess 630a, 630b, 630n generates a predicted aggregate value for an entity using (trained) machine learning model 708, and the predicted aggregate value may be compared, in monitoring subprocess 632a, 632b, 632n, to an observed aggregate value of the entity, which is updated after each transaction of ongoing transactions of the entity. Monitoring subprocess 632a, 632b, 632n may include multi-threaded processes to compare, in real-time (e.g., as data is being communicated/received, as soon as data is practically available after data is communicated/received, during processing and/or communication of messages related to an event such as a transaction, at the time of processing and/or making a decision related to an event, and/or the like), actual aggregate values to predicted aggregate values to identify changes in behavior based on deviations satisfying dynamic thresholds 712. Memory 118 may further act as a model store to store and manage different machine learning models for different entities, configurations, and classifications, which may be used by the server cluster 722.

As shown in FIG. 6, at step 11, first process flow 602 may include updating machine learning model 708 periodically, based on monitored transactions from second process flow 604. For example, transaction processing system 108 and/or modeling system 116 may automatically and periodically update (e.g., retrain) machine learning model 708 based on monitored transactions from second process flow 604.

As shown in FIG. 6, at step 12, first process flow 602 may include updating dynamic thresholds 712 for entities based on monitored transactions from second process flow 604. For example, because entity deviations are regularly determined in second process flow 604, transaction processing system 108 and/or modeling system 116 may use such ongoing deviation determinations to update (e.g., adjust and/or generate new) dynamic thresholds 712, which may be used to determine what constitutes normal or typical behavior for an entity.

As shown in FIG. 6, at step 13, second process flow 604 may include subprocess 640, which includes providing entity-facing services (e.g., risk mitigation processes) based on monitoring subprocess 632a, 632b, 632n of server cluster 722. For example, transaction processing system 108, modeling system 116, and/or monitoring system 112 may execute, or cause to be executed, at least one action based on the determination that an entity's behavior has changed (e.g., the entity's deviation satisfies the dynamic threshold 712 for the entity). In some non-limiting embodiments or aspects, alert subprocess 634a, 634b, 634n of server cluster 722 may trigger the transmission of an alert from monitoring system 112 to the entity in response to determination that the entity's behavior has changed. Additionally or alternatively, alert subprocess 634a, 634b, 634n of server cluster 722 may trigger an alert to transaction processing system 108 (and/or to issuer system 114, acquirer system 106, and/or merchant system 104), which may cause transaction processing system 108 (and/or to issuer system 114, acquirer system 106, and/or merchant system 104) to further evaluate the behavior of the entity before executing further actions (e.g., further risk mitigation processes).

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising:
at least one processor configured to:
receive transaction data associated with at least one transaction associated with an entity;
determine at least one aggregate value based on at least a portion of the transaction data for the at least one transaction;
generate at least one predicted aggregate value for the entity by inputting historic transaction data associated with a plurality of historic transactions associated with the entity to a machine learning model;
determine a deviation of the at least one aggregate value from the at least one predicted aggregate value;
compare the deviation to a dynamic threshold associated with the entity; and
in response to determining that the deviation satisfies the dynamic threshold, trigger at least one risk mitigation process associated with the entity.

2. The system of claim 1, wherein, when receiving the transaction data associated with the at least one transaction, the at least one processor is configured to:
receive the transaction data associated with the at least one transaction in a first time period; and
wherein the at least one processor is further configured to:
receive the historic transaction data associated with the plurality of historic transactions in a training time period preceding the first time period;
determine at least one historic aggregate value based on at least a portion of the historic transaction data for the plurality of historic transactions, based on a type of entity associated with the plurality of historic transactions; and
train the machine learning model with the at least one historic aggregate value, wherein the machine learning model is configured to predict at least one future value of transaction data for future transactions.

3. The system of claim 1, wherein a type of the entity comprises at least one of: transaction account, merchant, acquirer, issuer, or any combination thereof; and wherein the at least one risk mitigation process comprises at least one of: temporarily declining future transactions associated with the entity, transmitting an alert to the entity, temporarily disabling system access for the entity, or any combination thereof.

4. The system of claim 1, wherein the at least one processor is further configured to automatically and periodically update the dynamic threshold based on ongoing transactions associated with the entity.

5. The system of claim 4, wherein the deviation is based at least partly on a moving standard deviation, and wherein, when updating the dynamic threshold based on the ongoing transactions associated with the entity, the at least one processor is configured to:
determine the deviation of the at least one aggregate value from the at least one predicted aggregate value for each subperiod of a time period in which the ongoing transactions are completed, to produce a plurality of deviations; and
update the dynamic threshold after each subperiod of the time period based at least partly on a maximum value of the plurality of deviations.

6. The system of claim 5, wherein the at least one processor is further configured to retrain the machine learning model based on the ongoing transactions to produce an updated machine learning model, and wherein, when determining the deviation of the at least one aggregate value from the at least one predicted aggregate value for each subperiod of the time period, the at least one processor is configured to:
regenerate the at least one predicted aggregate value for the entity based on the updated machine learning model.

7. A computer-implemented method, comprising:
receiving, with at least one processor, transaction data associated with at least one transaction associated with an entity;
determining, with at least one processor, at least one aggregate value based on at least a portion of the transaction data for the at least one transaction;
generating, with at least one processor, at least one predicted aggregate value for the entity by inputting historic transaction data associated with a plurality of historic transactions associated with the entity to a machine learning model;
determining, with at least one processor, a deviation of the at least one aggregate value from the at least one predicted aggregate value;
comparing, with at least one processor, the deviation to a dynamic threshold associated with the entity; and
in response to determining that the deviation satisfies the dynamic threshold, triggering, with at least one processor, at least one risk mitigation process associated with the entity.

8. The computer-implemented method of claim 7, wherein receiving the transaction data associated with the at least one transaction comprises:
receiving the transaction data associated with the at least one transaction in a first time period;
the method further comprising:
receiving, with at least one processor, the historic transaction data associated with the plurality of historic transactions in a training time period preceding the first time period;
determining, the at least one processor, at least one historic aggregate value based on at least a portion of the historic transaction data for the plurality of historic transactions, based on a type of entity associated with the plurality of historic transactions; and
training, with at least one processor, the machine learning model with the at least one historic aggregate value, wherein the machine learning model is configured to predict at least one future value of transaction data for future transactions.

9. The computer-implemented method of claim 7, wherein a type of the entity comprises at least one of: transaction account, merchant, acquirer, issuer, or any combination thereof.

10. The computer-implemented method of claim 9, wherein the at least one risk mitigation process comprises at least one of: temporarily declining future transactions associated with the entity, transmitting an alert to the entity, temporarily disabling system access for the entity, or any combination thereof.

11. The computer-implemented method of claim 7, further comprising automatically and periodically updating, with at least one processor, the dynamic threshold based on ongoing transactions associated with the entity.

12. The computer-implemented method of claim 11, wherein the deviation is based at least partly on a moving standard deviation, and wherein updating the dynamic threshold based on the ongoing transactions associated with the entity comprises:
determining the deviation of the at least one aggregate value from the at least one predicted aggregate value for each subperiod of a time period in which the ongoing transactions are completed, to produce a plurality of deviations; and
updating the dynamic threshold after each subperiod of the time period based at least partly on a maximum value of the plurality of deviations.

13. The computer-implemented method of claim 12, further comprising retraining, with at least one processor, the machine learning model based on the ongoing transactions to produce an updated machine learning model, wherein determining the deviation of the at least one aggregate value from the at least one predicted aggregate value for each subperiod of the time period further comprises:
regenerating, during the time period, the at least one predicted aggregate value for the entity based on the updated machine learning model.

14. The computer-implemented method of claim 7, wherein the machine learning model is a long short-term memory (LSTM) model.

15. A computer program product comprising at least one non-transitory computer-readable medium comprising program instructions that, when executed by at least one processor, cause the at least one processor to:
receive transaction data associated with at least one transaction associated with an entity;
determine at least one aggregate value based on at least a portion of the transaction data for the at least one transaction;
generate at least one predicted aggregate value for the entity by inputting historic transaction data associated with a plurality of historic transactions associated with the entity to a machine learning model;
determine a deviation of the at least one aggregate value from the at least one predicted aggregate value;
compare the deviation to a dynamic threshold associated with the entity; and
in response to determining that the deviation satisfies the dynamic threshold, trigger at least one risk mitigation process associated with the entity.

16. The computer program product of claim 15, wherein the program instructions that cause the at least one processor to receive the transaction data associated with the at least one transaction, cause the at least one processor to:
receive the transaction data associated with the at least one transaction in a first time period; and
wherein the program instructions further cause the at least one processor to:
receive the historic transaction data associated with the plurality of historic transactions in a training time period preceding the first time period;
determine at least one historic aggregate value based on at least a portion of the historic transaction data for the plurality of historic transactions, based on a type of entity associated with the plurality of historic transactions; and
train the machine learning model with the at least one historic aggregate value, wherein the machine learning model is configured to predict at least one future value of transaction data for future transactions.

17. The computer program product of claim 15, wherein a type of the entity comprises at least one of: transaction account, merchant, acquirer, issuer, or any combination thereof; and wherein the at least one risk mitigation process comprises at least one of: temporarily declining future transactions associated with the entity, transmitting an alert to the entity, temporarily disabling system access for the entity, or any combination thereof.

18. The computer program product of claim 15, wherein the program instructions further cause the at least one processor to automatically and periodically update the dynamic threshold based on ongoing transactions associated with the entity.

19. The computer program product of claim 18, wherein the deviation is based at least partly on a moving standard deviation, and wherein the program instructions that cause the at least one processor to update the dynamic threshold based on the ongoing transactions associated with the entity, cause the at least one processor to:
determine the deviation of the at least one aggregate value from the at least one predicted aggregate value for each subperiod of a time period in which the ongoing transactions are completed, to produce a plurality of deviations; and
update the dynamic threshold after each subperiod of the time period based at least partly on a maximum value of the plurality of deviations.

20. The computer program product of claim 19, wherein the program instructions further cause the at least one processor to retrain the machine learning model based on the ongoing transactions to produce an updated machine learning model, and wherein the program instructions that cause the at least one processor to determine the deviation of the at least one aggregate value from the at least one predicted aggregate value for each subperiod of the time period, cause the at least one processor to:
regenerate the at least one predicted aggregate value for the entity based on the updated machine learning model.
